(19) United States
(12) Patent Application Publication
(10) Pub. No.: US 2008/0018983 A1
(43) Pub. Date: Jan. 24, 2008

(54) Color display system for reducing a false color between each color pixel

(76) Inventors: Fusao Ishii, Menlo Park, CA (US); Yoshihiro Maeda, Tokyo (JP); Hirotoshi Ichikawa, Tokyo (JP)

Correspondence Address: Bo-In Lin, 13445 Mandoli Drive, Los Altos Hills, CA, 94022, US

(21) Appl. No.: 11/827,455

(22) Filed: Jul. 11, 2007

Related U.S. Application Data
(60) Provisional application No. 60/830,263, filed on Jul. 12, 2006.

(51) Int. Cl. G02B 26/02

(52) U.S. Cl. 359/290

(57) ABSTRACT

This invention provides new control schemes and system configuration to reduce the rainbow effect usually encountered in the field sequential color display systems. By controlling R, G, B color simultaneously using multiple display device systems provide higher quality color display and reducing the rainbow effect. Therefore multiple display device systems have almost same phenomena as the rainbow effect in one frame period. The representative device of this invention is a deformable mirror device that is controlled by the pulse width modulation control or time dividing sequence. The brightness of one color light is determined through total amount of the time of the modulating spatial light modulator elements in one frame. And each color light from spatial light modulator element is combined and projected on a screen. An observer integrated each color image light through one frame to recognize the color. Each color light is modulated for different time period among each color spatial light modulator elements. By modulating different periods among R, G and B color is employed to reduce the false color.

This application is a Non-provisional Application of a Provisional application 60/830,263 filed on Jul. 12, 2006. The Provisional application 60/830,263 is a Continuation in Part (CIP) application of pending U.S. patent application Ser. Nos. 11/121,543 filed on May 3, 2005. The application Ser. No. 11/121,543 is a Continuation in Part (CIP) Application of three previously filed applications. These Three applications are 10/698,620 filed on Nov. 1, 2003, 10/699,140 filed on Nov. 1, 2003, and 10/699,143 filed on Nov. 1, 2003 by the Applicant of this patent applications. The disclosures made in these patent applications are hereby incorporated by reference in this patent application.

### TECHNICAL FIELD

This invention relates to image display system. More particularly, this invention relates to display system with a specially configured and controlled spatial light modulator or light sources for reducing the rainbow effect caused by the false colors in color display utilizing the color sequential display technologies.

### BACKGROUND ART

Even though there are significant advances made in recent years on the technologies of implementing electromechanical micromirror devices as spatial light modulator, there are still limitations and difficulties when employed to provide high quality images display. Specifically, by applying a color sequential display system to project the display images the images have an undesirable “rainbow” effect. Particularly, the display system of the HDTV format becomes popular and an image size on a screen becomes bigger and bigger like over 100″ diagonal size. The pixel size on the screen is more than 1 mm when specification is that 100″ size image including 1920×1080 pixels. Similarly 50″ size image and XGA pixels, the pixel size is 1 mm. The magnification of the projecting optics is from 50 to 130. An observer can see each of pixels on the screen, for these reasons, the display systems require high number of gray scales controlled by a word representing the gray scales with a length more than 10 bit to 16 bit and the rainbow effect must also be effectively eliminated in order to provide high quality display system. Furthermore, when the display images are digitally controlled, the image qualities are adversely affected due to the fact that the image is not displayed with sufficient number of gray scales.

Electromechanical micromirror devices have drawn considerable interest because of their application as spatial light modulators (SLMs). A spatial light modulator requires an array of a relatively large number of micromirror devices. In general, the number of devices required ranges from 60,000 to several million for each SLM. Referring to FIG. 1A for a digital video system 1 disclosed in a relevant U.S. Pat. No. 5,214,420 that includes a display screen 2. A light source 10 is used to generate light energy for ultimate illumination of display screen 2. Light 9 generated is further concentrated and directed toward lens 12 by mirror 11. Lens 12, 13 and 14 form a beam columnator to operative to columnate light 9 into a column of light 8. A spatial light modulator 15 is controlled by a computer through data transmitted over data cable 18 to selectively redirect a portion of the light from path 7 toward lens 5 to display on screen 2. The SLM 15 has a surface 16 that includes an array of switchable reflective elements, e.g., micromirror devices 32, such as elements 17, 27, 37, and 47 as reflective elements attached to a hinge 30 that shown in FIG. 1B. When element 17 is in one position, a portion of the light from path 7 is redirected along path 6 to lens 5 where it is enlarged or spread along path 4 to impinge the display screen 2 so as to form an illuminated pixel 3. When element 17 is in another position, light is not redirected toward display screen 2 and hence pixel 3 would be dark.

The on-and-off states of micromirror control scheme as that implemented in the U.S. Pat. No. 5,214,420 and by most of the conventional display system imposes a limitation on the quality of the display. Specifically, when applying conventional configuration of control circuit has a limitation that the gray scale of conventional system (PWM between ON and OFF states) is limited by the LSB (least significant bit, or the least pulse width). Due to the On-Off states implemented in the conventional systems, there is no way to provide shorter pulse width than LSB. The least controllable brightness adjustment, which determines gray scale, is the light reflected during the least pulse width. The limited gray scales lead to degradations of image display.

Specifically, in FIG. 1C an exemplary circuit diagram of a prior art control circuit for a micromirror according to U.S. Pat. No. 5,285,407. The control circuit includes memory cell 32. Various transistors are referred to as “M*” where * designates a transistor number and each transistor is an insulated gate field effect transistor. Transistors M5, and M7 are p-channel transistors; transistors, M6, M8, and M9 are n-channel transistors. The capacitances, C1 and C2, represent the capacitive loads presented to memory cell 32. Memory cell 32 includes an access switch transistor M9 and a latch 32a, which is the basis of the static random access switch memory (SRAM) design. All access transistors M9 in a row receive a DATA signal from a different bit-line 31a. The particular memory cell 32 to be written is accessed by turning on the appropriate row select transistor M9, using the ROW signal functioning as a wordline. Latch 32a is formed from two cross-coupled inverters; M5/M6 and M7/M8, which permit two stable states. State 1 is Node A high and Node B low and state 2 is Node A low and Node B high.

The dual states switching as illustrated by the control circuit controls the micromirrors to position either at an ON or an OFF angular orientation as that shown in FIG. 1A. The brightness, i.e., the gray scales of display for a digitally control image system is determined by the length of time the micromirror stays at an ON position. The length of time a micromirror is controlled at an ON position is in turned controlled by a multiple bit word. For simplicity of illustration, FIG. 1D shows the “binary time intervals” when control by a four-bit word. As that shown in FIG. 1D, the time durations have relative values of 1, 2, 4, 8 that in turn define the relative brightness for each of the four bits where 1 is for the least significant bit and 8 is for the most significant bit. According to the control mechanism as shown, the minimum controllable differences between gray scales for showing different brightness is a brightness represented by a “least significant bit” that maintaining the micromirror at an ON position.

When adjacent image pixels are shown with great degree of different gray scales due to a very coarse scale of controllable gray scale, artifacts are shown between these adjacent image pixels. That leads to image degradations. The image degradations are specially pronounced in bright areas of display when there are “bigger gaps” of gray scales between adjacent image pixels. It was observed in an image of a female model that there were artifacts shown on the forehead, the sides of the nose and the upper arm. The artifacts are generated due to a technical limitation that the digital controlled display does not provide sufficient gray scales. At the bright spots of display, e.g., the forehead, the sides of the nose and the upper arm, the adjacent pixels are displayed with visible gaps of light intensities.

As the micromirrors are controlled to have a fully ON and fully OFF position, the light intensity is determined by the length of time the micromirror is at the fully ON position. In order to increase the number of gray scales of display, the speed of the micromirror must be increased such that the digital control signals can be increased to a higher number of bits.

However, when the speed of the micromirrors is increased, a strong hinge is necessary for the micromirror to sustain a required number of operational cycles for a designated lifetime of operation, In order to drive the micromirrors supported on a further strengthened hinge, a higher voltage is required. The higher voltage may exceed twenty volts and may even be as high as thirty volts. The micromirrors manufacture by applying the CMOS technologies probably would not be suitable for operation at such higher range of voltages and therefore the DMOS micromirror devices may be required. In order to achieve higher degree of gray scale control, a more complicate manufacturing process and larger device areas are necessary when DMOS micromirror is implemented. Conventional modes of micromirror control are therefore facing a technical challenge that the gray scale accuracy has to be sacrificed for the benefits of smaller and more cost effective micromirror display due to the operational voltage limitations.

There are many patents related to light intensity control. These patents include U.S. Pat. Nos. 5,589,852, 6,232,963, 6,592,227, 6,648,476, and 6,819,064. There are further patents and patent applications related to different shapes of light sources. These patents includes U.S. Pat. Nos. 5,442,414, 6,036,318 and Application 20030147052. The U.S. Pat. No. 6,746,123 discloses special polarized light sources for preventing light loss. However, these patents and patent application do not provide an effective solution to overcome the limitations caused by insufficient gray scales in the digitally controlled image display systems.

Furthermore, there are many patents related to spatial light modulation that includes U.S. Pat. Nos. 20,25,143, 2,682,010, 2,681,423, 4,087,810, 4,292,732, 4,405,209, 4,454,541, 4,592,628, 4,615,595, 4,728,185, 4,767,192, 4,842,396, 4,907,862, 5,214,420, 5,287,096, 5,506,597, 5,489,952, 6,064,366, 6,535,319, and 6,880,936. However, these inventions have not addressed and provided direct resolutions for a person of ordinary skill in the art to overcome the above-discussed limitations and difficulties.

Additional disclosures are made by Kiser, David, K. at el. in U.S. Pat. No. 6,947,020 shows a multiple SLM devices and how to deal with the a problem of “color break. Although three-chip systems generally provide higher color quality than their counterpart field sequential color systems and do not suffer from the rainbow effect, such multi-SLM device systems do have their disadvantages. More specifically, the light paths in these three-chip optics engines are very complex, thereby increasing the overall system complexity and size. Also, because of this complexity, conventional three-chip SLM device systems are higher in cost. Note that two-chip systems may suffer from the same disadvantages as both the field sequential color systems and the three-chip systems.

Further disclosures are made by Choi, Soon-cheol in U.S. Pat. No. 6,781,731. This patent shows a plurality of color light sources and the incident lights are onto the mirror array from different directions. Also, in the one panel type, because the red, green, and blue light beams are processed by being modulated in a time sequence, the amount of light beam used by the micromirror device is reduced by ⅓; compared to a 3 panel type. Also, because the red, green, and blue light beams need to be continuously refreshed, a color break phenomenon is severe. However, in the present invention, the amount of light is improved compared to the conventional one panel type. That is, although white color is reduced by ⅓; in the amount of light, which is the same as in the conventional technology, in a case of a single color, the same amount of light as in the 3-panel type can be obtained. In the case of combining two colors, the amount of light is reduced by ⅔; so that brightness is improved compared to the conventional one panel type. Furthermore, because the frequency of refresh is reduced in the present invention, color break phenomenon can be reduced

Further disclosures are made in U.S. Pat. No. 6,970,148 by Itoh, Goh et al. The color breakup caused by the jumping movement of the eyes can be suppressed by increasing the subfield frequency. However, this method fails to sufficiently suppress the color break up resulting from the hold effect. The color breakup resulting from the hold effect can be reduced by substantially increasing the subfield frequency. However, substantially increasing the subfield frequency creates a new problem. That is, loads on driving circuits for the display device may increase. As described above, in the methods proposed to prevent motion pictures from blurring, one frame is divided into subfields used for image display and subfields used for black display. However, disadvantageously, the brightness of the image may generally decrease or the maximum brightness of the image must be increased. As a result, it is difficult to obtain high-quality images. Further, if color images are displayed on the basis of the field-sequentially additive color mixing system by dividing one frame into a plurality of subfields, then possible color breakup makes it difficult to obtain high-quality images. Further, if the subfield frequency is increased to suppress the color breakup, loads on the driving circuits may disadvantageously increase.

Further disclosures are made in U.S. Pat. No. 6,536,904 by Kunzman, Adam J. Sequential color systems exhibit an undesirable characteristic when eye motion occurs in localized area of black and white pixels in a given image. For relatively slow moving objects, leading edges appear to have a color hew to them, which corresponds to the first color in the color sequence while trailing edges appear to a have color hew of the last color in the color sequence. In scenes that induce rapid eye motion, a color rainbow effect is created that has the appearance of color ghost images in these black and white areas of the picture. In the past, this undesirable color separation has been addressed by means of faster sequencing of the colors; either by faster rotation of the color wheel or by splitting the color wheel filters into multiple sets of R-G-B segments. However, both of these approaches introduce negative factors, such as: (1) audible noise and less mechanical stability when operating the color wheel at higher speeds, (2) decreased efficiency (loss of brightness) due to additional color wheel spokes when adding additions filter segments, and (3) higher cost and (4) increased temporal artifacts (pulse width modulation noise).

Therefore, a need still exists in the art of image display systems applying digital control of a micromirror array as a spatial light modulator to provide new and improved systems such that the above-discussed difficulties can be resolved.

### SUMMARY OF THE INVENTION

The present invention relates to a display system that may be implemented as a deformable mirror device controlled by the pulse width modulation control or time dividing sequence. The brightness of one color light is determined through total amount of the time of the modulating SLM elements in one frame. And each color light from SLM element is combined and projected on a screen. An observer integrated each color image light through one frame to recognize the color. Each color light is modulated for different time period among each color SLM elements. By modulating different periods among R, G and B color is employed to reduce the false color.

These and other objects and advantages of the present invention will no doubt become obvious to those of ordinary skill in the art after having read the following detailed description of the preferred embodiment, which is illustrated in the various drawing figures.

### BRIEF DESCRIPTION OF FIGURES

The present invention is described in detail below with reference to the following Figures.

FIGS. 1A to 1D are drawings for providing background and prior art display technologies of this invention.

FIG. 2 is a conceptual diagram showing the operation of a liquid crystal color projection apparatus as related art of the invention.

FIG. 3 is a conceptual diagram showing the operation of typical micromirror devices as related art of the invention.

FIG. 4 is a conceptual diagram showing an exemplary configuration of the color display system according to one embodiment of the invention.

FIG. 5 is a cross-sectional view showing an exemplary configuration of a pixel section in one of spatial light modulators that form the color display system according to one embodiment of the invention.

FIG. 6A is a conceptual diagram showing the ON state of a micromirror that forms a pixel in the spatial light modulator.

FIG. 6B is a conceptual diagram showing the OFF state of the micromirror that forms a pixel in the spatial light modulator.

FIG. 6C is a conceptual diagram showing the oscillation state of the micromirror that forms a pixel in the spatial light modulator.

FIG. 7A is a conceptual diagram showing an example of controlling the ON state of the micromirror that forms a pixel in the spatial light modulator.

FIG. 7B is a conceptual diagram showing an example of controlling the OFF state of the micromirror that forms a pixel in the spatial light modulator.

FIG. 7C is a conceptual diagram showing an example of controlling the oscillation state of the micromirror that forms a pixel in the spatial light modulator.

FIG. 8 is a diagram for showing the modulation timing-diagram implemented in a controller to reduce the false colors according to an embodiment of this display.

FIG. 9 is a diagram for showing another modulation timing-diagram implemented in a controller to reduce the false colors according to an embodiment of this display.

FIG. 10 is a diagram for showing another modulation timing-diagram implemented in a controller to reduce the false colors according to an embodiment of this display.

FIG. 11 is a diagram for showing another modulation timing-diagram implemented in a controller to reduce the false colors according to an embodiment of this display.

FIG. 12 is a conceptual diagram showing an exemplary configuration of the single-panel color display system according to another embodiment of the invention.

FIG. 13 is a conceptual diagram showing an exemplary configuration of the three-panel color display system according to another embodiment of the invention.

FIG. 14A is a side view showing an exemplary configuration of the two-panel color display system according to another embodiment of the invention.

FIG. 14B is a front view showing an exemplary configuration of the two-panel color display system according to another embodiment of the invention.

FIG. 14C is a rear view showing an exemplary configuration of the two-panel color display system according to another embodiment of the invention.

FIG. 14D is a plan view showing an exemplary configuration of the two-panel color display system according to another embodiment of the invention.

FIG. 15 is a system diagram for showing a one SLM display system that has a plurality of color pixel elements to reduce false color in an image display.

FIG. 16 is a diagram for showing a four-color display scheme to further improve the image quality to reduce false color with yellow pixels that is reflected or projected as yellow color to compensate the modulating periods of the primary RGB colors.

FIG. 17 is a system diagram for showing one LCD display system that has half size pixels for two colors R and B with other panel for green color to improve the image quality by using the green color that is the most important color for human eyes to recognize the gray scales.

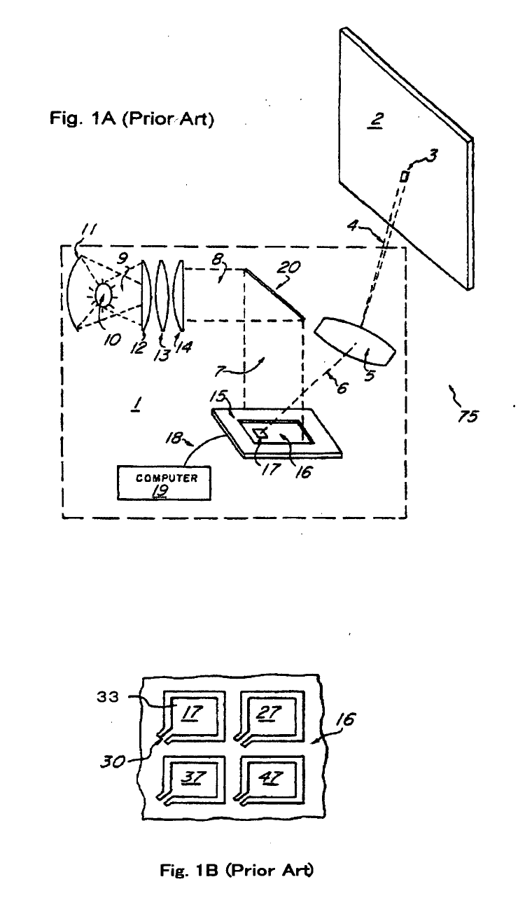

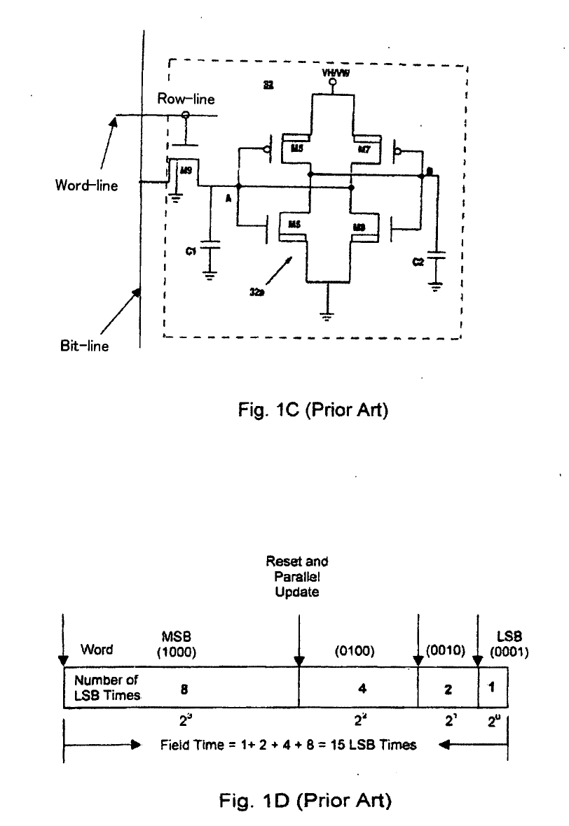

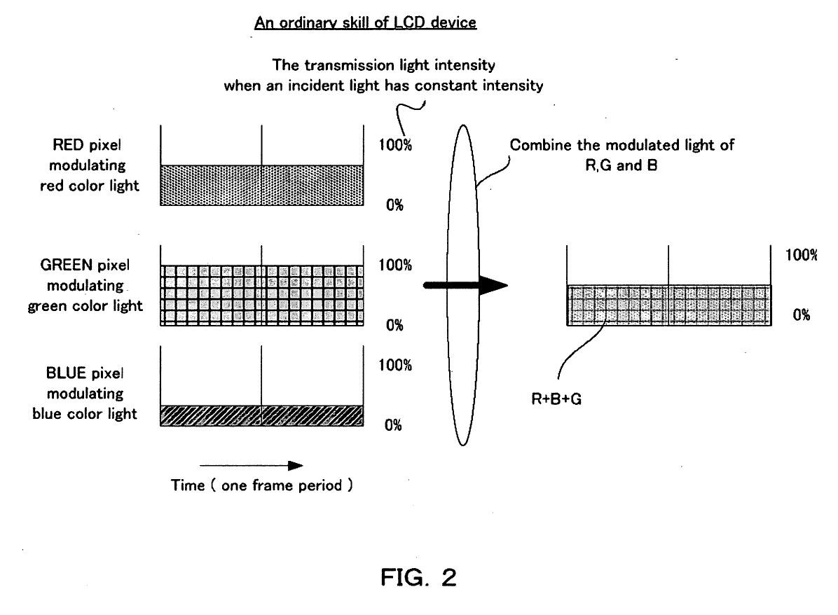

### DESCRIPTION OF PREFERRED EMBODIMENTS

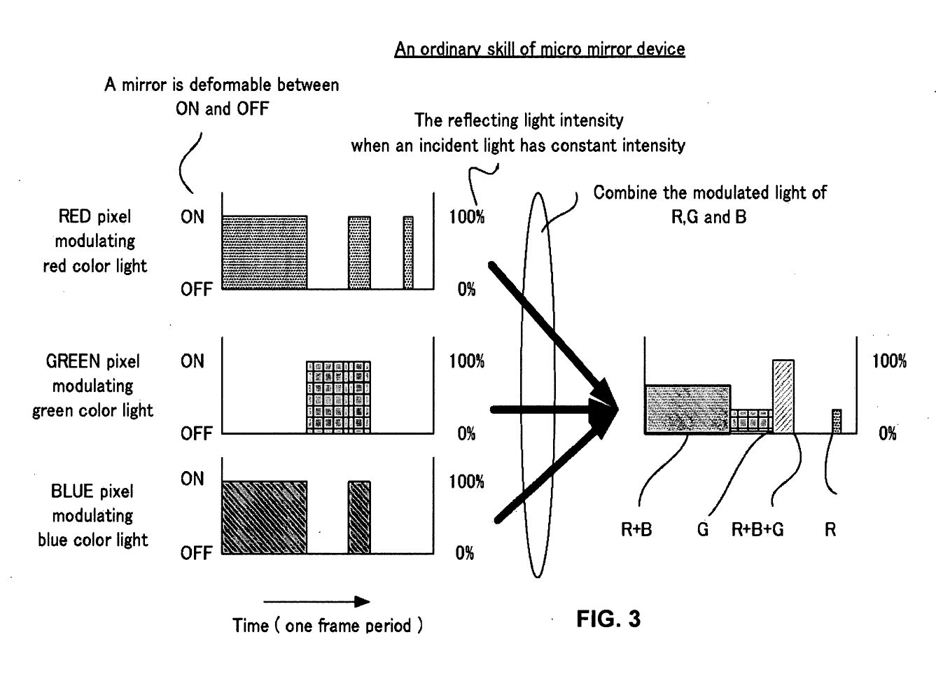

For better understanding of the reasons that the false colors are generated and displayed in an image that cause rainbow effect in a color sequential display system, FIG. 2 and FIG. 3 are included to provide the different states of the micromirrors, and the control schemes of color sequential displays with timing diagrams.

Referring to FIG. 2 and FIG. 3 for specific combination of R, G, and B colors at different display time slots in a mirror and LCD or Liquid Crystal On Silicon (LCOS) systems that cause the display, of false colors that leads to the rainbow effect.

In a LIQUID CRYSTAL DISPLAY (LCD) or Liquid Crystal On Silicon (LCOS) systems, as illustrated in the left portion of FIG. 2, since brightness levels of the red light R, the green light G and the blue light B in the display period of one frame have respective fixed values based on display image data, the combined projection light R+G+B to be projected will not cause any period during which the RIG/B colors are separated from each other in the one frame period and hence cause no color breakup, as illustrated in the right portion of FIG. 2.

In contrast, in an image display system implemented with the DMDs (digital micromirror devices), as illustrated in the left portion of FIG. 3, when the ON/OFF control at RIG/B color display timings is carried out using PWM (Pulse Width Modulation), it is not guaranteed that the ON/OFF timings of the micromirrors in the display period of one frame coincide with each other, so that the combined light projected for image display may have variations in RIG/B color overlap in the display period of one frame, resulting in color breakup, as illustrated in the right portion of FIG. 3.

An exemplary embodiment solves the above-described color breakup problem in a color display system using DMDs (digital micromirror devices) as the SLM (Spatial Light Modulator) in the way described below.

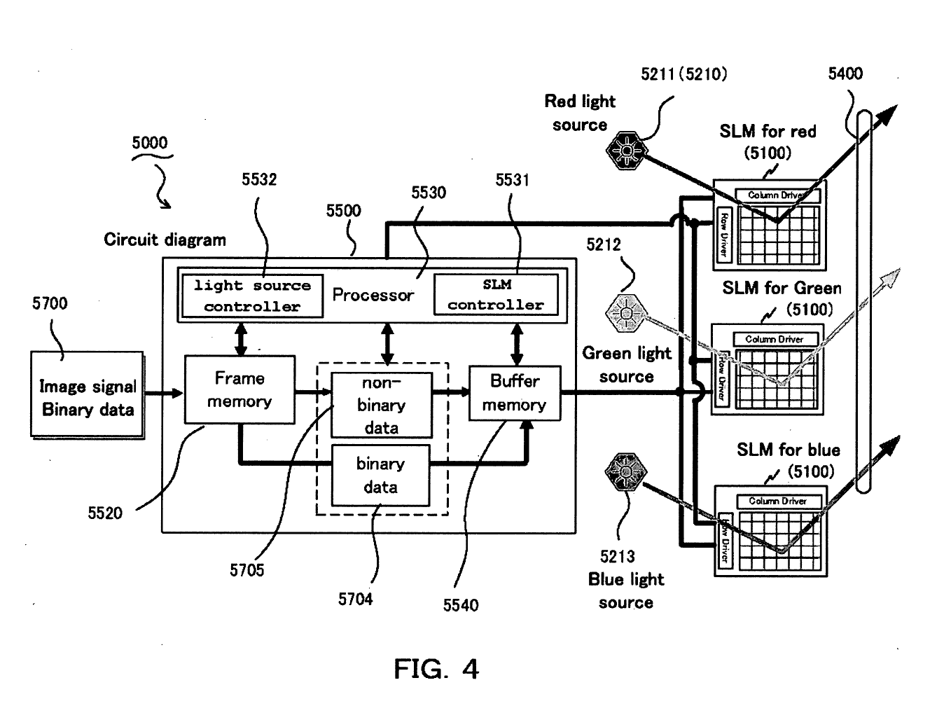

FIG. 4 is a conceptual diagram showing an exemplary configuration of the color display system according to the present embodiment. The color display system 5000 according to the present embodiment includes a plurality of spatial light modulators 5100, a control unit 5500 that controls the plurality of spatial light modulators 5100, a variable light source 5210, and a projection optical system 5400. The variable light source 5210 includes a red laser light source 5211, a green laser light source 5212, and a blue laser light source 5213. These laser light sources emit incident light beams 5601 having respective colors RIG/B onto the respective spatial light modulators 5100. The control unit 5500 includes a frame memory 5520, a controller 5530, and a buffer memory 5540. The controller 5530 includes an SLM controller 5531 that controls the individual spatial light modulators 5100 and a light source controller 5532. The frame memory 5520 temporarily stores input digital video data 5700 externally input as binary data. The SLM controller 5531 uses the input digital video data 5700 stored in the frame memory 5520 to produce binary data 5704 and non-binary data 5705, which are control signals for controlling ON/OFF and oscillation of micromirrors 5112 in the spatial light modulators 5100, and outputs these control signals to the individual spatial light modulators 5100 via the buffer memory 5540. The light source controller 5532 controls light emission intensities and light emission timings of the red laser light source 5211, the green laser light source 5212, and the blue laser light source 5213 that form the variable light source 5210.

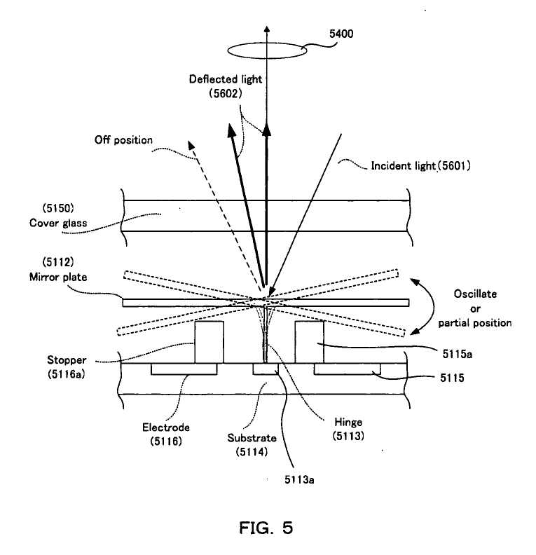

FIG. 5 is a cross-sectional view of one of individual pixel sections that form the spatial light modulator 5100 according to the present embodiment. As illustrated in FIG. 5, each mirror element 5111 includes a micromirror 5112 that is supported on a substrate 5114 via a hinge 5113 and has an angular movement flexibility to tilt to different angular positions relative to the hinge. A cover glass 5150 covers and protects the micromirror 5112. The area of each micromirror 5112 in one exemplary embodiment ranges from 20² μm to 110² μm. An OFF electrode 5116/an OFF stopper 5116a and an ON electrode 5115/an ON stopper 5115a on the opposite sides of the hinge 5113 in a symmetric manner are supported on the substrate 5114. A hinge electrode 5113a is also disposed on the substrate 5114 under the hinge 5113.

A predetermined voltage is applied between the OFF electrode 5116 and the hinge electrode 5113a to produce a coulomb force, which attracts and tilts the micromirror 5112 until it abuts the OFF stopper 5116a. Then, the incident light 5601 incident on the micromirror 5112 is reflected toward an OFF position light path that is deviated from the optical axis of the projection optical system 5400.

A predetermined voltage is applied between the ON electrode 5115 and the hinge electrode 5113a to produce a coulomb force, which attracts and tilts the micromirror 5112 until it abuts the ON stopper 5115a. Then, the incident light 5601 incident on the micromirror 5112 is reflected toward an ON position light path that coincides with the optical axis of the projection optical system 5400.

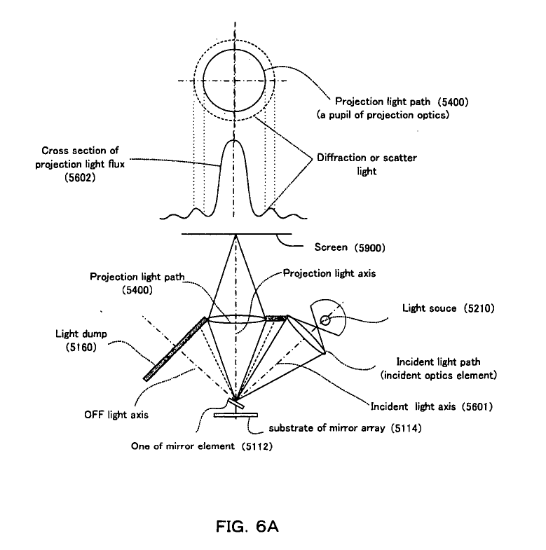

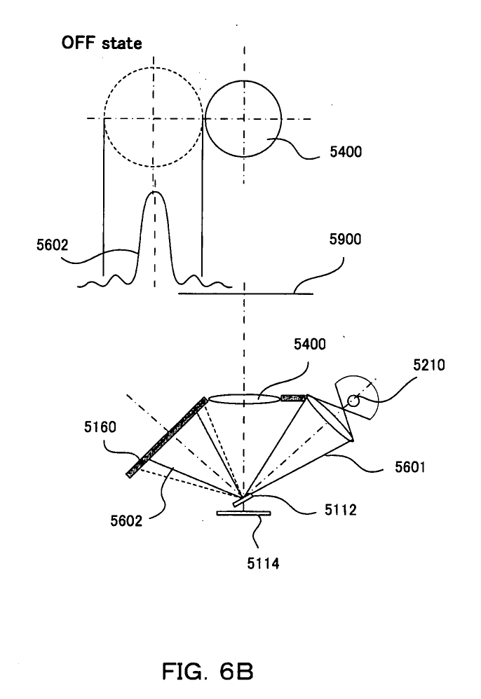

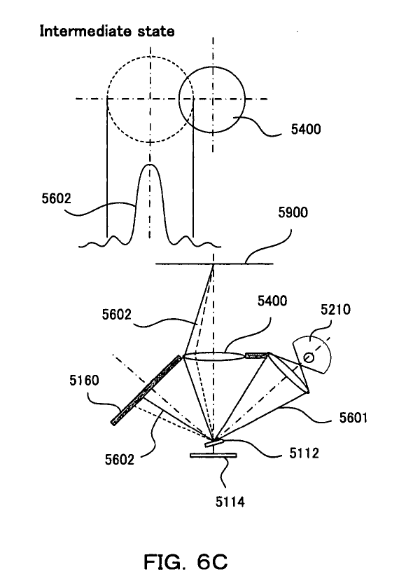

FIGS. 6A, 6B and 6C are diagrams for conceptually showing examples of operation of the mirror element 5111 in the color display system according to the present embodiment. FIG. 6A shows the ON state of the micromirror 5112. In this case, the incident light 5601 from the variable light source 5210 is reflected off the micromirror 5112 as reflected light 5602 to project in the optical axis direction of the projection optical system 5400. The light path of the reflected light 5602 coincides with the optical axis of the projection optical system 5400, so that all reflected light 5602 is projected on a screen 5900. FIG. 6B shows the OFF state of the micromirror 5112. In this case, the light path of the reflected light 5602 is completely deviated off from the optical axis of the projection optical system 5400 and the reflected light 5602 is absorbed in a light absorber 5160, so that no reflected light 5602 will be projected on the screen 5900. FIG. 6C is a diagram that shows an example of generating the intermediate gray scales between the ON and OFF states by controlling the micromirror 5112 to oscillate between the ON and OFF states. When the micromirror 5112 oscillates between the ON and OFF states, part of the light path of the reflected light 5602 overlaps with the projection optical system 5400. Therefore, part of the reflected light 5602 reaches the screen 5900 through the projection optical system 5400.

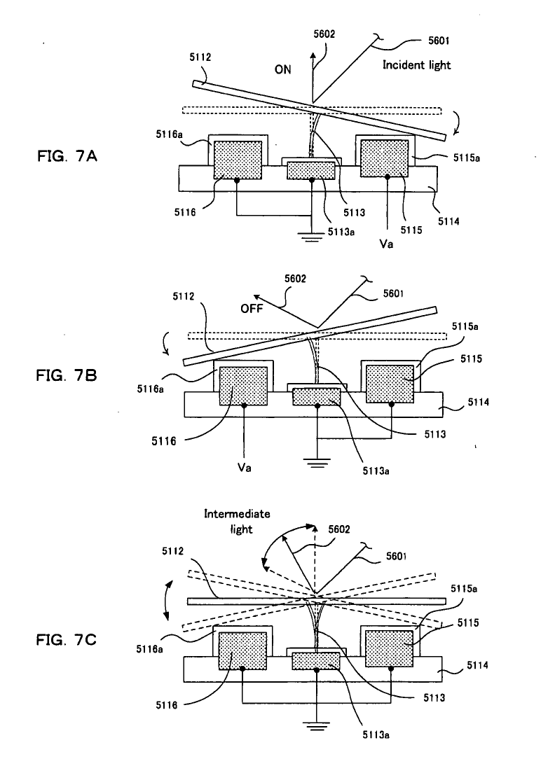

FIGS. 7A, 7B and 7C are diagrams for conceptually showing the methods for achieving the ON state, the OFF state and the oscillation state of the micromirror 5112 described above. As illustrated in FIG. 7A, when the micromirror 5112 is turned ON, a driving voltage Va (charge) based on the binary data 5704 and non-binary data 5705 is applied to the ON electrode 5115 with the hinge electrode 5113a and the OFF electrode 5116 grounded. A coulomb force attracts and tilts the micromirror 5112 until it abuts the ON stopper 5115a. As illustrated in FIG. 7B, when the micromirror 5112 is turned OFF, the driving voltage Va is applied to the OFF electrode 5116 with the hinge electrode 5113a and the ON electrode 5115 grounded so as to tilt the micromirror 5112 until it abuts the OFF stopper 5116a. FIG. 7C shows an example of controlling the micromirror 5112 oscillates between the ON and OFF states. A ground voltage is applied to all the hinge electrode 5113a, the OFF electrode 5116 and the ON electrode 5115 thus terminating the driving voltage Va and the elastic oscillation of the hinge 5113 cause the micromirrors 5112 to oscillate between the ON and OFF states.

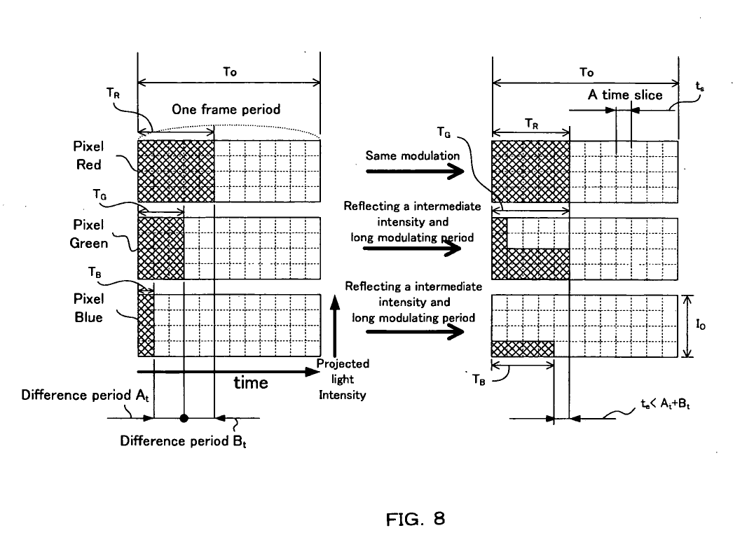

Referring to FIG. 8 wherein the left side drawing shows a system practiced by those of ordinary skill in the art while the right side drawing shows the functions performed by a system of this embodiment. In this embodiment as shown in the right side drawing, the system changes the projection light intensity by controlling the mirror element or the light source wherein the micromirror is controlled with intermediate state modulation or the incident light intensity is controlled with an intermediate intensity or brightness between the maximum intensity and the OFF state. The red pixel is displaying as same as ordinary skill through the frame and then the green light intensity lower about half while 4 time slices. The green light intensity lower about half while 4 time slices. The mirror element of blue pixel is controlled to be long period modulation close to the red. The mirror element is modulated using intermediate modulation to reduce the reflecting light intensity. Furthermore the blue light intensity is lower to match the total amount of projected light intensity with originally blue pixel. In order to reduce the difference of the modulating period because an observer recognizes the incorrect color at the time of the period At and Bt as shown in FIG. 8. An observer sees only red color at the time period B that is a false color period. By controlling the display periods as shown in FIG. 8, the difference period like the “At+Bt” is reduced.

According to FIG. 8 as that illustrated in the left portion, for a conventional display system, the spatial light modulator 5100 is irradiated with light having a maximum brightness 10 of the variable light source 5210 only in the period that starts from the start time of the display period of one frame T₀ and lasts for the duration corresponding to the brightness of each color (red pixel display period T_{R}, green pixel display period T_{G}, and blue pixel display period T_{B}).

Thus, FIG. 8 illustrates an example where the red pixel display period T_{R} corresponds to the red light that has the highest brightness among the three colors. The red light has a longest ON-time because the display T_{R} in the input digital video data 5700 is the longest in the display period of one frame T₀. On the other hand, compared with the red pixel display time, the green pixel display period T_{G} is shorter by a difference period of Bt. The pixel display period T_{B} is for the blue light. The blue pixel display has a less brightness than the green light. Compared to the red pixel display time, the blue pixel display time is shorter by a difference period of At. The differences of the display periods for different color pixels often cause a color breakup problem.

The diagram shown on the right side of FIG. 8 illustrates a technique implemented by an exemplary embodiment to address this problem. The control unit 5500 controls the individual mirror elements 5111 in the spatial light modulators 5100 and the variable light source 5210 in such a way that the longest red pixel display period T_{R} matches as closely as possible with the other display periods. As illustrated in FIG. 8 the red pixel display time is substantially matched with the green pixel display period T_{G} and the blue pixel display period T_{B}.

Specifically, the SLM controller 5531 and the light source controller 5532 in the controller 5530 use the input digital video data 5700 to produce binary data 5704 and non-binary data 5705 for controlling the brightness of each color pixel shown in the left portion of FIG. 8 (the first step). A process is carried out to match the green pixel display period T_{G} (the second time slice tₛ with the red pixel display time. The brightness of the variable light source 5210 or the oscillation of the micromirror 5112 is controlled to make the brightness of the green pixel about half of the maximum brightness 10 of the reflected light 5602 so as to match the green pixel display period T_{G} with the red pixel display period T_{R} (the second step). Similarly, in the blue pixel display period T_{B}, the variable light source 5210 or the oscillation of the micromirror 5112 is controlled to reduce the brightness of the blue pixel to a quarter of the original brightness and make the blue pixel display period T_{B} four times the original length. By applying these processes, the difference tₑ between the length of the extended blue pixel display period T_{B} and the lengths of the red pixel display period T_{R} and the green pixel display period T_{G} becomes equal to or smaller than the sum of the difference periods At and Bt. By matching the display periods in the display period of one frame T₀ without changing the original display brightness for each color pixel, it is possible to prevent color breakup thus eliminating the degradation of the image quality due to the color breakup when the spatial light modulation is applied for color display.

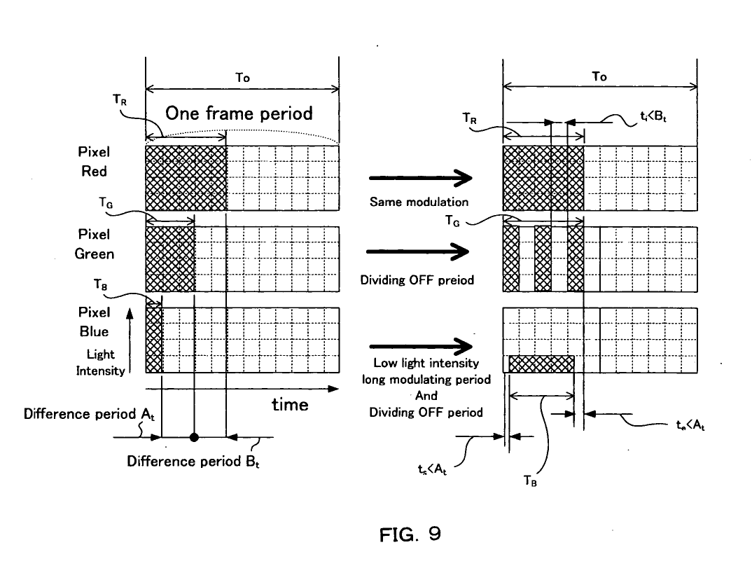

Referring to FIG. 9 that includes two sides, wherein the diagram on the left side shows a system practiced by those of ordinary skill in the art while the diagram on the right side shows the functions performed by a system of this embodiment. In this embodiment as shown in the diagram on the right side, the system divides the Green pixel frame into three ON time slices with an OFF period inserted between ON periods. The OFF periods are shorter than the conventional OFF period and the OFF period inserted between the on time slices is shorter than a recognizable time duration of the eyes of an observer. FIG. 9 furthermore shows the OFF periods for displaying the blue color are divided into two short periods. Therefore, according to FIG. 9, the OFF periods t are dispersedly placed between the time slices when the green pixel display period T_{G} and the blue pixel display period T_{B}, are shorter than the pixel display period T_{R} for the red light that has the highest brightness Furthermore, the different in display times are longer than one time slice tₛ. The green and blue reflected light 5602 are controlled to have the maximum brightness 10. This applies to the green pixel display period T_{G} in this example and the OFF periods tᵢ are dispersedly placed between the time slices and the OFF periods tᵢ are smaller than a difference period Bt, which is the difference between the green pixel display period T_{G} and the red pixel display period T_{R}.

The brightness of the variable light source 5210 or the oscillation of the micromirror 5112 is controlled to reduce the brightness of the reflected light 5602 (reduced to ¼ in this case) in the blue pixel display period T_{B}. The blue pixel display period is equal to or shorter than the time slice tₛ. Furthermore, the controller extends the blue pixel display period T_{B}. At the same time, at the ends of the blue pixel display period T_{B}, OFF periods tₛ and tₑ are provided that are shorter than the difference period At, which is the difference between the blue pixel display period T_{B} and the green pixel display period T_{G}.

Therefore, the color breakup problems are resolved when the control shown in FIG. 9 is employed. The red pixel display period T_{R}, the green pixel display period T_{G}, and the blue pixel display period T_{B} are arranged with no offset in the display period of one frame T₀.

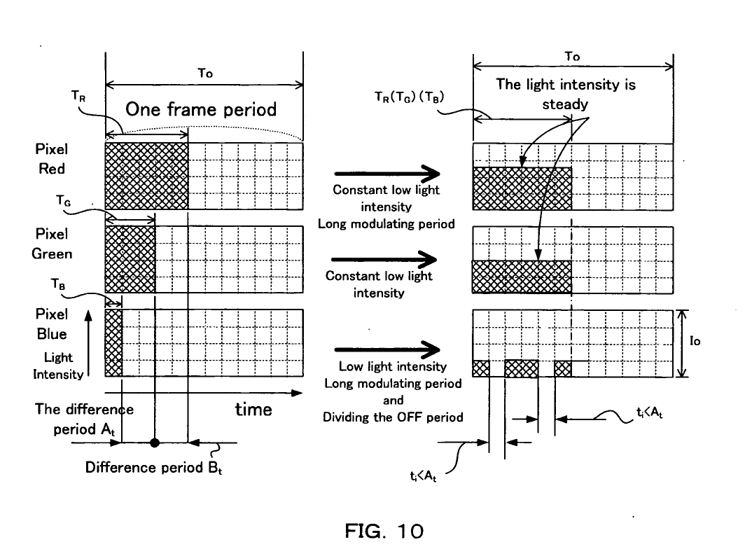

Referring to FIG. 10 wherein the diagram on the left-side shows a system practiced by those of ordinary skill in the art while the diagram on the right side shows the functions performed by a system of this embodiment. According to the diagram on the right side, the system displays the Red pixel and Green pixel. The display periods have the same modulation period using the intermediate state of the mirror element. The system displays the blue pixels with the OFF period divided into two periods as that shown in FIG. 10. FIG. 10 further illustrate that the false color occurs only in two short periods.

According to the diagram on the right side of FIG. 10, the brightness of the variable light source 5210 or the oscillation of the micromirrors 5112 is controlled to produce intermediate brightness values in such a way that the lengths of the red pixel display period T_{R}, the green pixel display period T_{G} and the blue pixel display period T_{B} are matched with each other. The blue light has the lowest brightness in the pixel display period T_{B}. The OFF period tᵢ shorter than the difference period At is placed between the time slices. With such color display control schemes, the red pixel display period T_{R}, the green pixel display period T_{G}, and the blue pixel display period T_{B} are arranged with no offset in the display period of one frame T₀, and the color breakup problems are resolved.

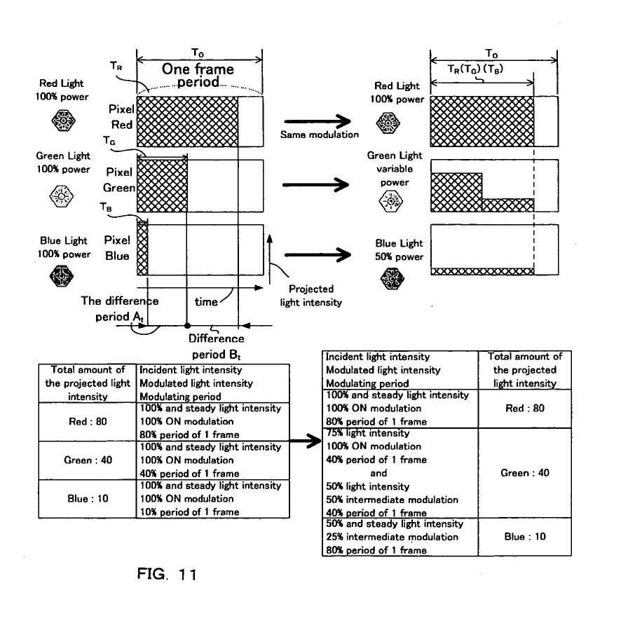

Referring to FIG. 11 for the control techniques implemented in this invention to resolve the false color problems by the combination of the variable incident light intensity and intermediate state modulation. The diagram on left side of FIG. 11 shows a system practiced by those of ordinary skill in the art while the diagram on the right side shows the functions performed by a system of this embodiment.

According to the diagram on the right side, the system displays colors in different period with variable period lengths as shown in the tables as part of FIG. 11. There are three variable lengths of display illustrated as the lengths of the red pixel display period T_{R}, the green pixel display period T_{G}, and the blue pixel display period T_{B}. The display times are matched with each other by extending the lengths of the display periods that are shorter and having lower brightness values (the green pixel display period T_{G} and the blue pixel display period T_{B} in this case).

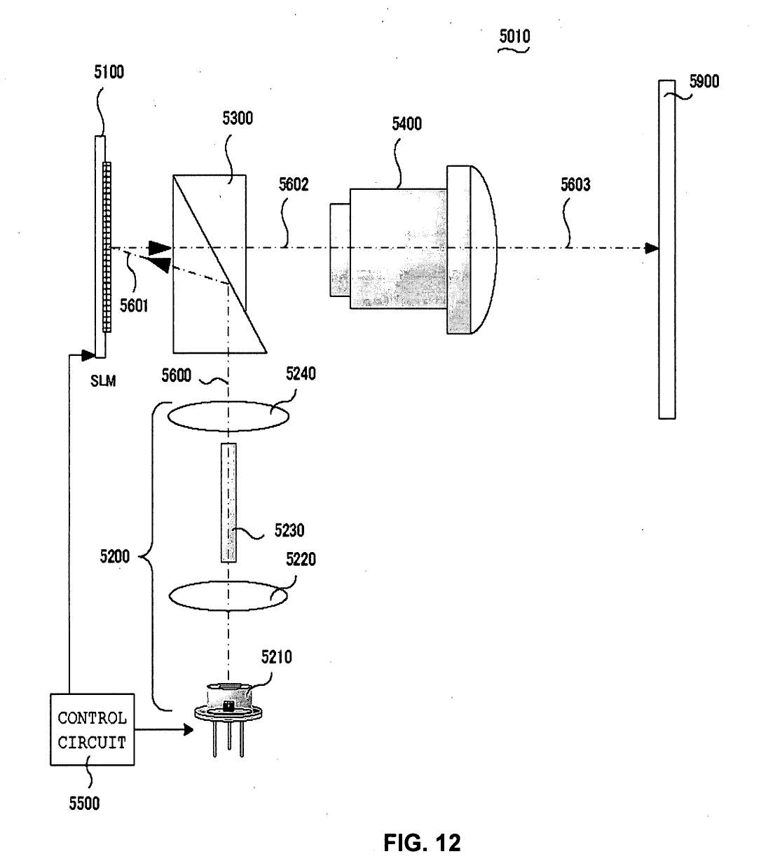

FIG. 12 is a diagram conceptually showing the configuration of the color display system according to one embodiment of the invention. As illustrated in FIG. 12, the color display system 5010 includes one spatial light modulator (SLM) 5100, a control unit 5500, a TIR prism (Total Internal Reflection prism) 5300, a projection optical system 5400, a light source optical system 5200 and a control unit 5500. The color display system 5010 is generally referred to as a single-panel color display system 5010 because the display system includes a single spatial light modulator 5100. The spatial light modulator 5100 and the TIR prism 5300 are disposed on the optical axis of the projection optical system 5400. The light source optical system 5200 is disposed in such a way that its optical axis is perpendicular to the optical axis of the projection optical system 5400. The TIR prism 5300 allows the illumination light 5600 projected from the light source optical system 5200 disposed by the side of the TIR prism 5300 to project an incident light 5601 on the spatial light modulator 5100 at a predetermined oblique angle. The reflected light 5602 is perpendicularly reflected off the spatial light modulator 5100 to pass through the TIR prism 5300 into the projection optical system 5400. The projection optical system 5400 projects the reflected light 5602 transmitted from the spatial light modulator 5100 through the TIR prism 5300 onto a screen 5900 or the like as projection light 5603.

The light source optical system 5200 includes a variable light source 5210 that produces the illumination light 5600, a collector lens 5220 that focuses the illumination light 5600, a rod-like collector 5230, and a collector lens 5240. The variable light source 5210, the collector lens 5220, the rod-like collector 5230 and the collector lens 5240 are sequentially disposed on the optical axis of the illumination light 5600 that exits from the variable light source 5210 and incident on the side of the TIR prism 5300. In the color display system 5010, the one spatial light modulator 5100 is used to achieve color display on the screen 5900 in a color sequential manner. The variable light source 5210 includes a red laser light source 5211, a green laser light source 5212 and a blue laser light source 5213. The emission states of the light sources are independently controlled. One frame of display data is divided into a plurality of sub-fields (three sub-fields corresponding to R/G/B (Red/Green/Blue) in this case), and the red laser light source 5211, the green laser light source 5212 and the blue laser light source 5213 are turned on in a time-series manner during the time slots corresponding to the respective color sub-fields.

Also in the single-panel color display system 5010 illustrated in FIG. 12, the control unit 5500 controls the modulating operations of the variable light source 5210 and micromirrors 5112 in such a way that the display timings for the RIG/B colors in one frame are matched with each other as closely as possible. The matched display times thus achieving a high-performance color display system 5010 without image quality degradation due to the problems of color breakup, false contours and other similar problems. The problems of color break up are therefore resolved by color display control techniques as illustrated in FIGS. 8, 9, 10 and 11.

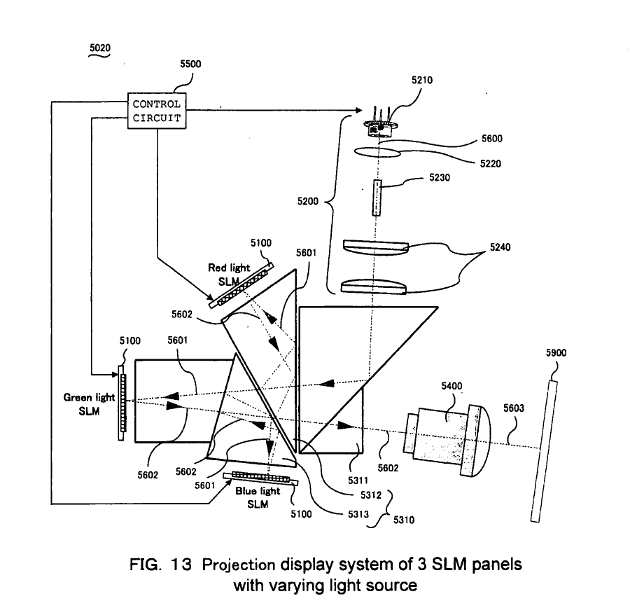

FIG. 13 is a diagram for showing the concept of a configuration for controlling the color display system according to another embodiment of the invention. The color display system 5020 differs from the color display system 5010 described above in that the color display system 5020 is a so-called multiple-panel (three-panel in this case) color display system including a plurality of spatial light modulators 5100. The color display system 5020 includes a plurality of spatial light modulators 5100. The display system further includes a light separation and combination optical system 5310 disposed between a projection optical system 5400 and the individual spatial light modulators 5100. The light separation and combination optical system 5310 includes a plurality of TIR prisms 5311, 5312 and 5313. The TIR prism 5311 serves to guide illumination light 5600 projected from the side of the optical axis of the projection optical system 5400 toward the spatial light modulators 5100 as incident light 5601. The TIR prism 5312 serves to separate red (R) light from the incident light 5601 coming through the TIR prism 5311, allow the red light to be incident on the spatial light modulator 5100 for red light, and guide reflected light 5602 reflected therefrom to the TIR prism 5311.

Similarly, the TIR prism 5313 separates the blue (B) and green (G) light from the incident light 5601 coming through the TIR prism 5311 to allow these lights to project on the spatial light modulators 5100 for blue and green light, and then guide the reflected light 5602 reflected from the SLM 5100 to the TIR prism 5311. Therefore, spatial light modulating operations for the three colors RIG/B are simultaneously carried out at the three spatial light modulators 5100, and the resultant modulated, reflected light 5602 is projected as projection light 5603 on a screen 5900 through the projection optical system 5400 for color display.

The light separation and combination optical system is not limited to the light separation and combination optical system 5310 as that shown in this specific embodiment. Various embodiments are conceivable and are all included in the scopes of this invention. Also in the three-panel color display system 5020 illustrated in FIG. 13, a control unit 5500 controls modulating operations of a variable light source 5210 and micromirrors 5112 in such a way that the display timings for the R/G/B colors in one frame are matched with each other as closely as possible. A high-performance color display system 5020 is provided without image quality degradation due to color breakup, false contours and the like, as illustrated in FIGS. 8, 9, 10 and 11.

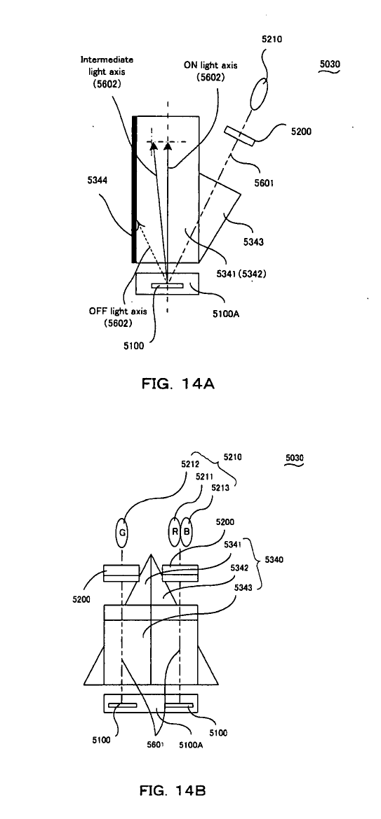

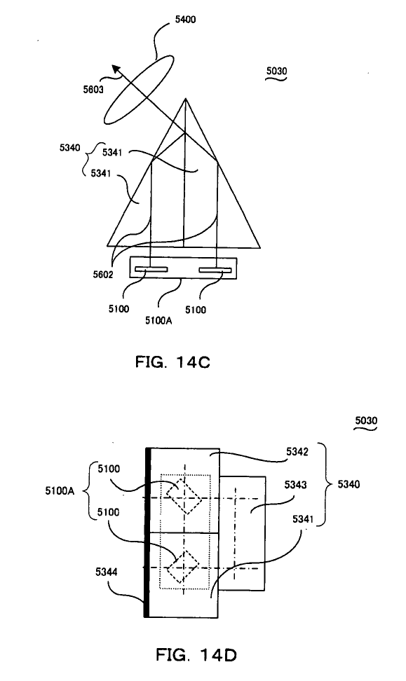

FIGS. 14A, 14B, 14C and 14D are configuration diagrams of the optical system of a color display system 5030 using a plurality of spatial light modulators 5100. FIG. 14A is a side view of the combination optical system according to the present embodiment. FIGS. 14B, 14C and 14D show a front view, a rear view and a top plan view of the combination optical system, respectively. The optical system according to the present embodiment includes a device package 5100A having a plurality of spatial light modulators 5100 integrally mounted, a color combination optical system 5340, a light source optical system 5200, and a variable light source 5210. Each of the plurality of spatial light modulators 5100 mounted in the device package 5100A is fixed in such a way that each side of the rectangular contour of the spatial light modulator 5100 is inclined at about 45 degrees in the horizontal plane to each side of the device package 5100A having a similar rectangular contour.

The color combination optical system 5340 is disposed above the device package 5100A. The color combination optical system 5340 is formed of right triangular column prisms 5341 and 5342, joined to each other into a substantially equilateral triangular column by joining the surfaces containing the longer sides of the right triangles, and a right triangular column light guide block 5343, the oblique surface of which joined to the side surfaces of the prisms 5341 and 5342 with the bottom side orienting upward. A light absorber 5344 is provided on the side surfaces of the prisms 5341 and 5342 opposite to the side surfaces on which the light guide block 5343 is attached.

Above the bottom of the light guide block 5343 are provided the light source optical system 5200 for a green laser light source 5212 and the light source optical system 5200 for a red laser light source 5211 and a blue laser light source 5213 with their optical axes perpendicular to the bottom of the light guide block 5343. An Illumination light 5600 is projected from the green laser light source 5212 and passes through the light guide block 5343 and the prism 5341 as illumination light 5601 and is incident on one of the spatial light modulators 5100 situated immediately under the prism 5341. An Illumination light 5600 is projected from the red laser light source 5211 and the blue laser light source 5213 and passes through the light guide block 5343 and the prism 5342 as illumination light 5601 and is incident on the other spatial light modulator 5100 situated immediately under the prism 5342.

The red and blue illumination light 5601 incident on the spatial light modulator 5100 is reflected as reflected light 5602 in the prism 5342 to an upward vertical direction when the micromirror 5112 is turned ON, then reflected off the outer side surface of the prism 5342 and the joined surface in this order, enters a projection optical system 5400, and exits as projection light 5603. The green illumination light 5601 incident on the spatial light modulator 5100 is reflected as reflected light 5602 in the prism 5341 to an upward vertical direction when the micromirror 5112 is turned ON, then reflected off the outer side surface of the prism 5341 and follows the same light path as that of the red and blue reflected light 5602 to enter the projection optical system 5400, and exits as projection light 5603.

The micromirror device according to the present embodiment thus has at least two modules of the spatial light modulator 5100 built in one device package 5100A. One module is irradiated only with the incident light 5601 from the green laser light source 5212. The other module of the spatial light modulator 5100 is irradiated with the incident light 5601 from at least one of the red laser light source 5211 and the blue laser light source 5213. The modulated light beams modulated in the two modules of the spatial light modulators 5100 are collected in the color combination optical system 5340 as described above. The modulated light is then expanded in the projection optical system 5400 and projected on a screen 5900 or the like as the projection light 5603.

Also in the two-panel color display system 5030 illustrated in FIGS. 14A to 14D, the modulating operations of the variable light source 5210 and the micromirrors 5112 are controlled in such a way that the display timings for the colors R/G/B in one frame are matched with each other as closely as possible, thus achieving the high-performance color display system 5030 without image quality degradation due to color breakup, false contours and the like, as illustrated in FIGS. 8, 9, 10 and 11.

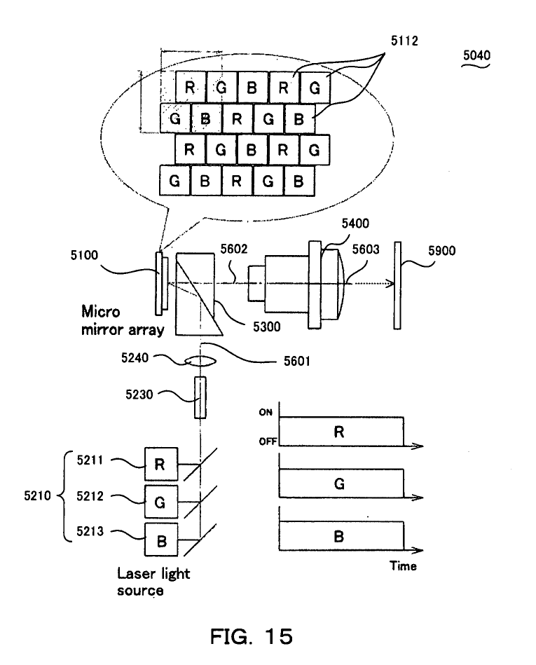

Referring to FIG. 15 for a single spatial light modulator (SLM) that includes a plurality of addressable deflecting elements, e.g., micromirrors. Each of these addressable elements is designated for projecting a particular primary color to function as a specific color pixel element. The incident light emitted from three lasers is combined to a single SLM. As also shown in FIG. 15, the light source may also be implemented as a lamp including three primary colors. The color display system 5040 illustrated in FIG. 15 has the same single-panel configuration as that of the color display system 5010 illustrated in FIG. 12. The components common to each other have common characters and the description thereof is omitted. In the color display system 5040 illustrated in FIG. 15, three micromirrors 5112 adjacent to each other in the spatial light modulator (SLM) 5100 are assigned to the three primary colors R/G/B. These micromirrors 5112 corresponding to the three primary colors R/G/B are disposed in a staggered pattern.

By illuminating the spatial light modulator 5100 with R/G/B incident light 5601 from the variable light source 5210 and controlling the ON/OFF states and oscillation of the micromirrors 5112 assigned to the three primary colors R/G/B, the incident light 5601 is brightness modulated into reflected light 5602, which is then projected on the screen 5900 through the projection optical system 5400 as projection light 5603. Also in the color display system 5040, it is possible to prevent color breakup by implementing the color display control techniques as described in FIGS. 9 to 12.

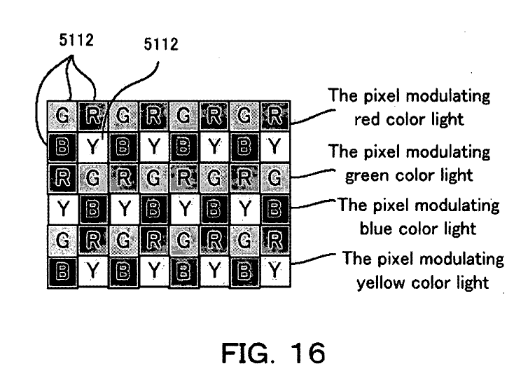

Referring to FIG. 16 an alternate embodiment of this invention with the pixel elements of the spatial light modulator (SLM) includes pixel elements designated for four different colors. These four different colors include three primary colors of red, green and blue (RGB) and further include a yellow color. A four-color system further improves the control of color display to reduce the false colors. The yellow pixels reflect or transmit yellow color to compensate for the modulation period of the primary RGB colors. Specifically, in FIG. 16, compared with the color display system 5040 described in FIG. 15, the image display system differs in that in addition to the micromirrors 5112 for the three primary colors R/G/B, there are provided micromirrors 5112 for yellow (Y) for compensating for the brightness values of the three primary colors to achieve four-color display. The micromirrors 5112 for the three primary colors R/G/B as well as yellow (Y) are arranged in a grid pattern.

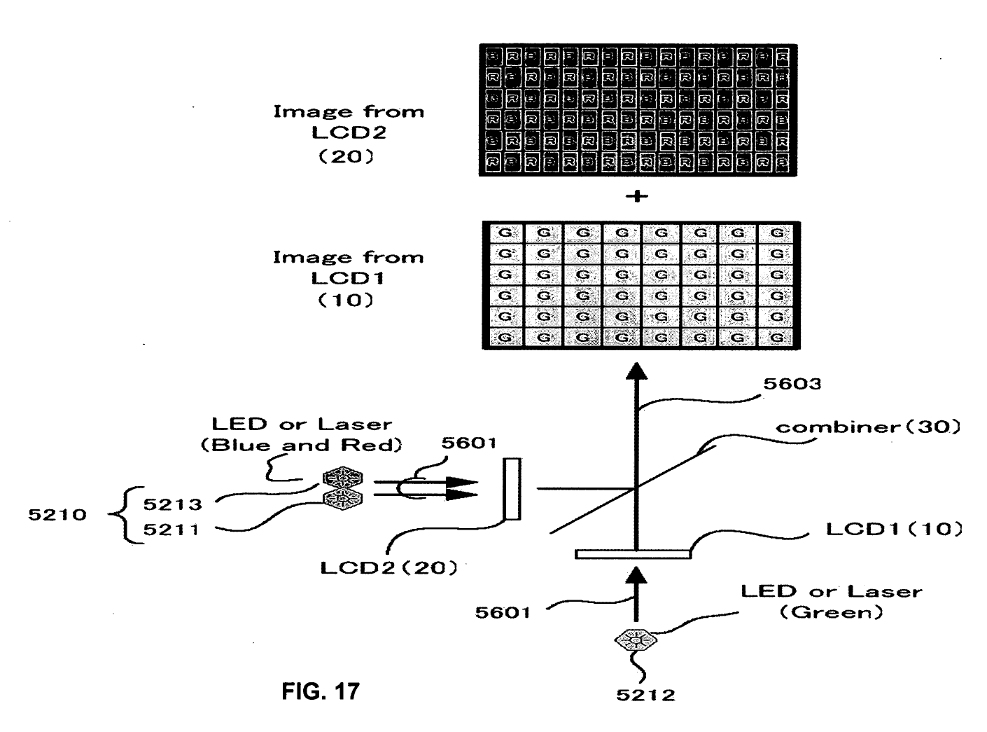

Referring to FIG. 17 for another embodiment of an image display system of this invention that includes a first LCD (liquid crystal display) panel. The first LCD has half size pixels for two colors R and B.

The display system further includes a second LCD that includes pixel elements of green color. The green color is the most important color of human eye to recognize different gray scales to provide improved color contrast. That is, the color display system 5050 illustrated in FIG. 17 includes an LCD panel 10, a second LCD panel 20, a light combiner 30, and a variable light source 5210. The LCD panel 10 uses its all liquid crystal cells to modulate green (G) light. The second LCD panel 20 has liquid crystal cells that modulate red (R) and blue (B) lights and these lights are alternately arranged.

The light combiner 30 is an optical system including a dichroic mirror or the like that reflects the red (R) and blue (B) light and transmits the green (G) light as well as combining and projecting the three primary color light. The G incident light 5601 that exits from the green laser light source 5212 is modulated at the LCD panel 10 and then passes through the light combiner 30. The R/B incident light 5601 that exits from the red laser light source 5211 and the blue laser light source 5213 is modulated at the LCD panel 20, reflected off the light combiner 30, combined with the G light and then projected as projection light 5603. Again, in the color display system 5050, it is possible to prevent color breakup by implementing color display control techniques as described in FIGS. 9-12 above.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A color display system comprising a light source for projecting a light of multiple colors to a spatial light modulator (SLM) for modulating the light of multiple colors and transmitting a modulated light to a projection optics to display a color image, said color display system further comprising:
a controller for controlling said SLM for reducing a difference of modulating periods for at least two colors whereby an intensity mismatch between displays of different colors is reduced.

2. The color display system of claim 1 wherein:
said controller further controlling said SLM to close a modulation starting time or ending time between at least two colors whereby an intensity mismatch between displays of different colors is reduced.

3. The color display system of claim 1 wherein:
said controller further controlling said SLM to reduce a period of a continuous non-modulated period for controlling a time a pixel of said SLM staying at an OFF state whereby an intensity mismatch between displays of different colors is reduced.

4. The color display system of claim 1 wherein:
said controller further controlling said SLM to maintain a modulated light intensity within a modulating period for at least two colors whereby an intensity mismatch between displays of different colors is reduced.

5. The color display system of claim 1 wherein:
said controller further converting and processing an image source signal to a control signal consisting of a plurality of digital data for controlling said modulating time of said SLM for different colors whereby an intensity mismatch between displays of different colors is reduced.

6. The color display system of claim 1 wherein:
said controller further controlling a state of ON/OFF of a plurality pixels of said SLM for projecting different primary colors and said controller further adjusting durations of an ON time for at least two pixels for reducing an ON time difference between two pixels for projecting at least two different primary colors.

7. The color display system of claim 1 wherein:
said controller further controlling said SLM to project uniform light intensity by maintain a modulated light intensity within a modulating period for at least two colors whereby an intensity mismatch between displays of different colors is reduced.

8. The color display system of claim 1 wherein:
said controller further controlling a plurality of pixels of said SLM to position said pixels to an ON state, an OFF state and an intermediate state within one frame of display time for reducing an intensity mismatch between displays of different colors.

9. A color display system comprising a light source for projecting a light of multiple colors to a spatial light modulator (SLM) for modulating the light of multiple colors and transmitting a modulated light to a projection optics to display a color image, said color display system further comprising:
a controller for controlling said light source for reducing a difference of light intensities between at least two different colors projected from said light source whereby an intensity mismatch between displays of different colors is reduced.

10. The color display system of claim 9 wherein:
said controller further controlling a plurality of mirror elements of said SLM to position said mirror elements to an ON state, an OFF state and an intermediate state within one frame of display time in synchronizing with said light intensities projected from said light source for reducing an intensity mismatch between displays of different colors.

11. The color display system of claim 9 wherein:
said light source further comprising a plurality of laser light sources projecting laser lights of different wavelength.

12. The color display system of claim 9 wherein:
said light source further comprising a plurality of light emitting diodes (LED) projecting lights of different wavelength.

13. The color display system of claim 9 wherein:
said controller further controlling a pulse width, a pulse number or a pulse interval for projecting light of different colors for reducing a difference of light intensities between at least two different colors projected from said light source whereby an intensity mismatch between displays of different colors is reduced.

14. The color display system of claim 1 further comprising:
at least two spatial light modulators for modulating lights of different colors.

15. The color display system of claim 1 wherein:
said SLM comprising a plurality of deformable mirror elements and adjacent mirror elements are designated for modulating lights of different colors.

16. The color display system of claim 1 wherein:
said SLM comprising a plurality of deformable mirror elements and at least one mirror element is designated for modulating lights of two different colors.

17. The color display system of claim 1 wherein:
said SLM comprising a plurality of micromirrors supporting on deflectable hinges for flexibly linking to different angular positions.

18. The color display system of claim 1 wherein:
said SLM comprising a LIQUID CRYSTAL DISPLAY or Liquid Crystal On Silicon (LCOS) and said controller controlling said SLM for modulating the incident light beam for generating an image.

19. The color display system of claim 1 wherein:
said display system is provided to generate a display image having more than 1,000 gray scales for at least one color.

20. The color display system of claim 1 wherein:
said SLM comprising a plurality of micromirrors having a substantially square shape and having a mirror length and width between approximately 20 μm to 110 μm.

21. The color display system of claim 1 wherein:
said controller further converting an image signal to a non-binary digital control signal for controlling said SLM.

22. The color display system of claim 1 wherein:
said controller further controlling a pulse width, a pulse number or a pulse interval of said light source for controlling an intensity of light of different colors; and
said controller further controlling said SLM to synchronize according to a positive integral number of clock cycles correlating to said pulse width of said light source for reducing an intensity mismatch between display of different colors.

23. A method for controlling a color display system using a micromirror device including a plurality of mirror elements as a spatial light modulator (SLM), the method comprising:
controlling said SLM to reduce a difference of modulating periods for at least two colors whereby an intensity mismatch between displays of different colors is reduced.
